(19) United States
(12) Patent Application Publication
(10) Pub. No.: US 2015/0009701 A1
(43) Pub. Date: Jan. 8, 2015

(54) RETROFIT LED LIGHT SOURCE FOR VEHICLE LAMPS

(71) Applicant: General Electric Company, Schenectady, NY (US)

(72) Inventors: Zoltán László Bakó, Budapest (HU); István MUDRA, Budapest (HU); M. Imre Molnár, Budapest (HU); László NAGY, Budapest (HU)

(73) Assignee: GENERAL ELECTRIC COMPANY, Schenectady, NY (US)

(21) Appl. No.: 13/937,087

(22) Filed: Jul. 8, 2013

(51) Int. Cl. F21V 29/00; F21K 99/00; B60Q 1/00; F21V 23/00

(52) U.S. Cl. CPC F21V 29/22; F21V 23/005; F21K 9/30; B60Q 1/0005
USPC 362/545; 362/382

(57) ABSTRACT

A lamp including a lamp base, an LED driver circuit connected to the lamp base, an LED light source connected to the driver circuit and located distal from the lamp base, and a power consumption/heat dissipating unit electrically connected to the lamp base. The LED driver circuit and the power consumption/heat dissipating unit being electrically parallel to the lamp base terminals. The lamp includes a pin jumper block in electrical connection with the power consumption/heat dissipating unit, and configured to electrically isolate the power consumption/heat dissipating unit from the lamp base with insertion or removal of a pin jumper.

### BACKGROUND

Many late model vehicles include electrical control systems which sense the operation of conventional vehicle lamps (e.g., directional, brake, fog, etc.) based on their power consumption. If the electrical control system does not detect power consumption above a minimum level, the control system will flag the lamp as an inoperative lamp. The control system can also alter the frequency of a directional lamp's illumination based on the low consumption level detection and alter the frequency of the flashes as a response to the low reading.

LED retrofit lamps are available in the marketplace. These retrofit LED lamps have a form that is accepted by the vehicle lamp socket. But, the conventional LED retrofit lamp has a low power consumption that is below the minimum limit expected by the vehicle electrical control system.

### BRIEF DESCRIPTION OF THE DRAWINGS

FIG. 1A depicts a perspective view of a retrofit LED vehicle lamp in accordance with some embodiments;

FIG. 1B depicts a cross section view of the retrofit LED vehicle lamp of FIG. 1A;

FIG. 2A depicts a perspective view of a retrofit LED vehicle lamp in accordance with other embodiments; and

FIG. 2B depicts a cross section view of the retrofit LED vehicle lamp of FIG. 2A.

### DETAILED DESCRIPTION

In accordance with embodiments, a retrofit light emitting diode (LED) vehicle lamp includes one or more LED light sources packaged in a form to fit vehicle lamp sockets and reflector units. Also included in the retrofit LED lamp is a power consumption/heat dissipating unit.

The expenditure of electric power by power consumption/heat dissipating unit in the retrofit LED lamp increases the power consumption sensed by the vehicle electric control system to approach figures of conventional stop lamps. Therefore, the electrical control system of the car senses an operative lamp. The power consumption/heat dissipating unit converts a certain portion of input electric power into heat so as to prevent fogging of the reflector body.

In accordance with embodiments, the retrofit LED lamp includes one or more high-power LED chips assembled in the same package as the power consumption/heat dissipating unit. The package itself is assembled so that the LED chips and the power consumption/heat dissipating unit are close to being thermally isolated. In one implementation, at least two high-power LED chips are positioned about (i.e., at near, or on), the longitudinal reference axis of the lamp. The LED chips are also positioned distal from the lamp base at about a distance which places the LED chips at about the same distance from the lamp base as the center of a conventional vehicle lamp. This positioning of the LED chips provides a wide-angle light distribution similar to that provided by an incandescent coil of conventional vehicle lamps (e.g., brake lamps, fog lamps, directional lamps, etc.). In accordance with some embodiments, the retrofit LED lamp can illuminate about a 270° irradiation angle, which provides an illumination pattern near or identical with that of conventional vehicle lamps.

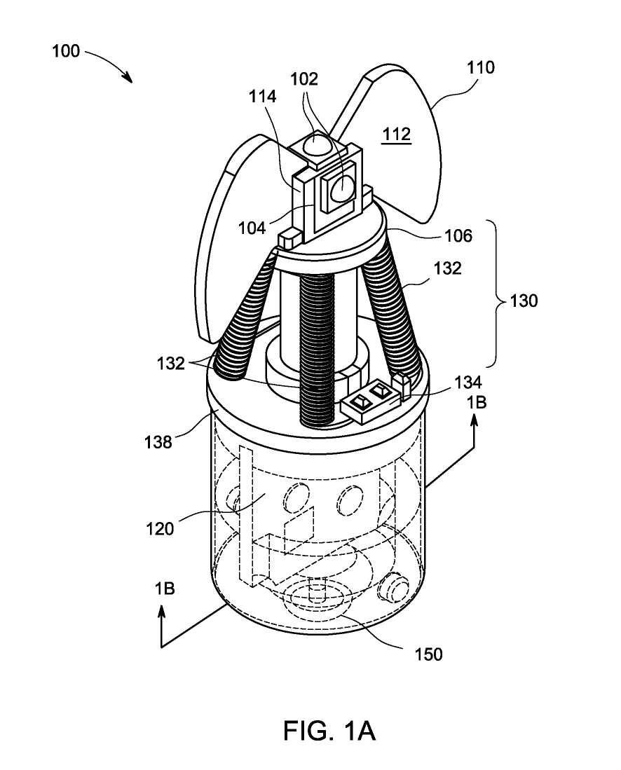

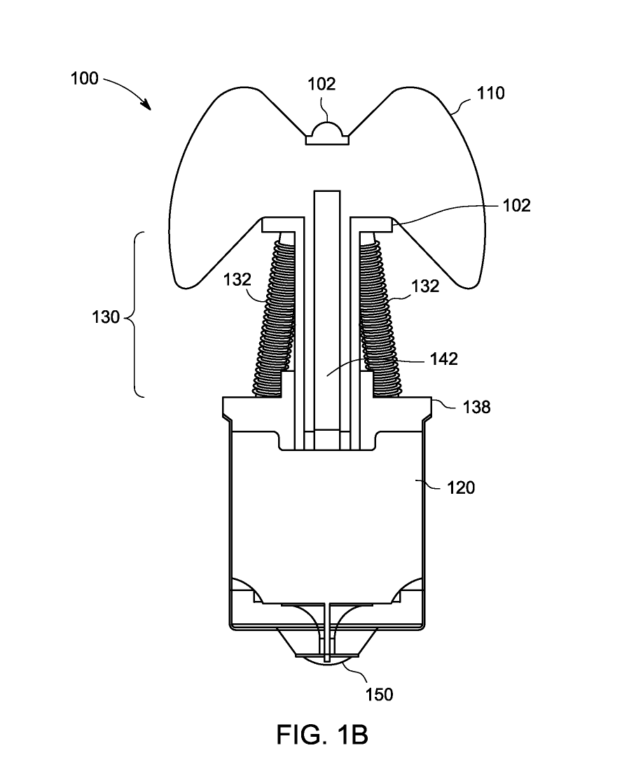

FIG. 1A depicts retrofit LED lamp 100 in accordance with some embodiments. FIG. 1B depicts a cross section of LED lamp 100 along arrows 1B of FIG. 1A. Lamp 100 includes an upper portion, distal from the lamp base, having two or more high-power LED chips 102 as light sources. These LED light sources are positioned on flexible PCB 104. In some implementations, this printed circuit board can be a thick film PCB.

The LED lamp includes LED mount 110, which includes thermal fins 112, block 114, and tube 142 (FIG. 1B). In accordance with an embodiment, the LED mount components (e.g., thermal fins 112, block 114, and tube 142) can be formed from an integral piece for example, aluminum or another light weight, heat conductive material.

Flexible PCB 104 is attachable to block 114. In one implementation, the PCB can be attached using a heat transfer adhesive. LED chips 102 can be electrically connected to form a circuit by using a flexible conductor foil (which can be the same material as flexible PCB 104), that can have an adhesive surface. The flexible conductor foil conforms to bends as the individual LED chips are placed at different surfaces of block 114. The LED light sources are placed at an angle off of the LED mount plane so as to illuminate the required angular region relative to the lamp reference axis.

The LED mount is supported by flange 106. Thermal fins 112 dissipate heat generated from below the LED light sources. Located below flange 106 in a mid-portion of the retrofit LED lamp is power consumption/heat dissipating unit 130. The power consumption/heat dissipating unit includes heating elements 132 and pin jumper block 134. The pin juniper block can accept a jumper which completes a circuit path that excludes power consumption/heat dissipating unit 130 from the circuit. The power consumption/heat dissipating unit can be excluded, when the retrofit LED lamp is used in vehicles not equipped with the electrical control system described above. In accordance with one embodiment the heating elements can be heater coils wound about a thermal insulated core. The heating elements can be electrically coupled to lamp base 150, or bypassed by insertion of a jumper into pin jumper block 134. In accordance with some embodiments, jumper block 134 can include a jumper to make an electrical connection from the lamp base to the heating elements. In these embodiments, removal of the jumper isolates the heating elements and effectively disconnects the power consumption/heat dissipating unit from electrical input power.

The lamp upper portion is supported and positioned by flange 106 which protrudes through flare 138. In accordance with some embodiments, flange 106 can be a thermally-insulating, high-temperature resistant plastic. This structural design can minimize the heat transfer from the power consumption/heat dissipating unit toward the thermal fins on LED mount 110.

Situated in a lower portion of lamp 100, proximal to the lamp base, is LED driver circuit 120. The LED driver converts the vehicle input voltage (e.g., 12 vdc, 24 vdc) to a level suitable for driving the LED light sources. LED driver 120 is in electrical connection with the vehicle electrical supply through lamp base 150. Lamp base 150 can be a standard vehicle lamp base that mates with conventional lamp sockets used in vehicles (e.g., BA15s, BA15d, BAU15s, etc.). In accordance with sonic, embodiments. LED driver 120 and power consumption/heat dissipating unit 130 are electrically parallel circuits with common connections at lamp base 150.

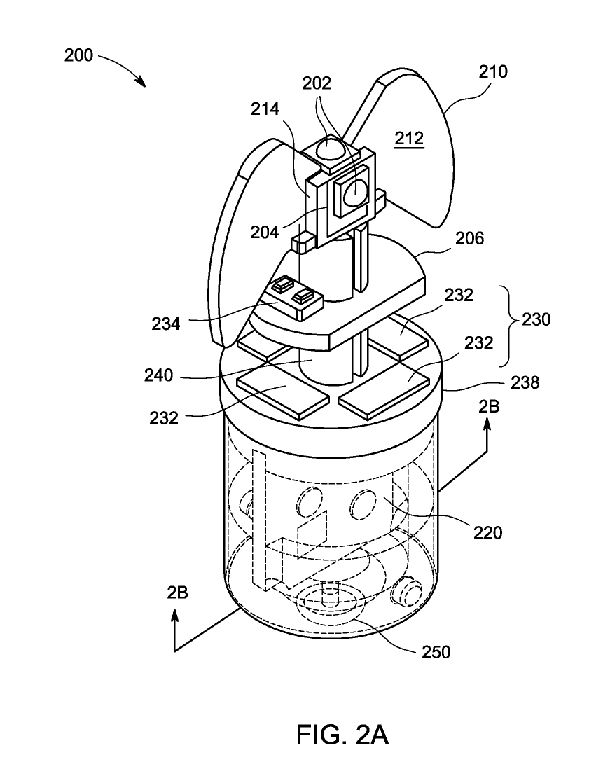

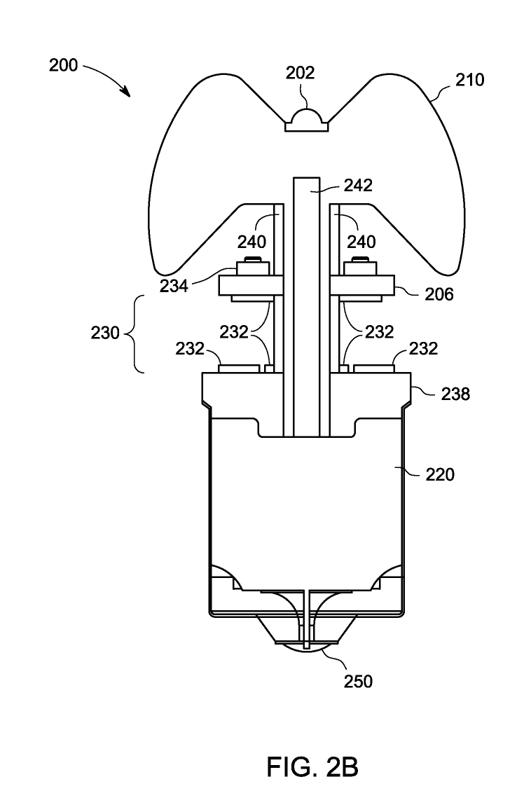

FIG. 2A depicts retrofit LED lamp 200 in accordance with some embodiments. FIG. 2B depicts a cross section of LED lamp 200 along arrows 2B of FIG. 2A, Lamp 200 includes an upper portion, distal from the lamp base, having two or more high-power LED chips 202 as light sources. These light sources are positioned on flexible PCB 204. In some implementations, this printed circuit board can be a thick film PCB.

The LED lamp includes LED mount 210, which includes thermal fins 212, block 214, and column 242 (FIG. 2B). In accordance with an embodiment, the LED mount components (thermal fins 212, block 214, and column 242) can be formed from an integral piece for example, aluminum or another light weight, heat conductive material.

Flexible PCB 204 is attachable to block 214. In one implementation, the PCB can be attached using a heat transfer adhesive. LED chips 202 can be electrically connected to form a circuit by using a flexible conductor foil (which can be the same material as flexible PCB 104), that can have an adhesive surface. The flexible conductor foil conforms to bends as the individual LED chips are placed at different surfaces of PCB 204. The LED light sources are placed at an angle off of the LED mount plane so as to illuminate the required angular region relative to the lamp reference axis.

The LED mount is supported and protrudes through by PCB 238. Thermal fins 212 dissipate heat generated from below the LED light sources. Located below PCB 206, in a mid-portion of the retrofit LED lamp, is power consumption/heat dissipating unit 230. The power consumption/heat dissipating unit includes heating elements 232 and pin jumper block 234. As described above, the pin jumper block can accept a jumper which completes a circuit path that excludes power consumption/heat dissipating unit 230 from the circuit. The power consumption/heat dissipating unit can be excluded when the retrofit LED lamp is used in vehicles not equipped with the electrical control system described above. In accordance with some embodiments, jumper block 234 can include a jumper to make an electrical connection from the lamp base to the heating elements. In these embodiments, removal of the jumper isolates the heating elements and effectively disconnects the power consumption/heat dissipating unit from electrical input power.

In accordance with one embodiment, heating elements 232 can be high-power resistive loads connected in series. In one implementation, six resistive loads are mounted on PCB 206 and 238. The heating elements can be electrically coupled to lamp base 250 through pin jumper block 234. The lamp upper portion is supported by spacers 240.

Situated in a lower portion of lamp 200 is LED driver circuit 220. The LED driver converts the vehicle input voltage (e.g., 12 vdc, 24 vdc) to a level suitable for driving the LED light sources. LED driver 220 is in electrical connection with the vehicle electrical supply through lamp base 250. Lamp base 250 can he a standard vehicle lamp base that mates with conventional lamp sockets used in vehicles (e.g., BA15s, BA15d, BAU15s, etc.) In accordance with some embodiments, LED driver 220 and power consumption/heat dissipating unit 230 are electrically parallel circuits with common connections at lamp base 250.

Although the retrofit LED lamp includes a power consumption/heat dissipating unit, the thermal fins protect the LED light sources from overheating. For example, the LED light source typically consumes about 1-2 watts, and the power consumption/heat dissipating unit typically consumes about 10-15 watts.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A lamp comprising:
a lamp base configured to be electrically connectable to a lamp socket, the lamp base having a positive terminal and a negative terminal;
a light emitting diode (LED) driver circuit having an input and an output, the input electrically connected to the lamp base;
an LED light source electrically connected to the output, the LED light source located distal from the lamp base; and
a power consumption/heat dissipating unit electrically connected to the lamp base;
wherein the LED driver circuit and the power consumption/heat dissipating unit are electrically parallel to the lamp base terminals.

2. The lamp of claim 1, wherein the LED driver circuit is located proximal to the lamp base.

3. The lamp of claim 1, wherein the power consumption/heat dissipating unit is located between the LED driver circuit and the LED light source.

4. The lamp of claim 1, including:
a pin jumper block in electrical connection with the power consumption/heat dissipating unit; and
the pin jumper block electrical connection configured to electrically isolate the power consumption/heat dissipating unit from the lamp base with one of insertion and removal of a pin jumper.

5. The lamp of claim 1, the power consumption/heat dissipating unit including one or more heating elements.

6. The lamp of claim 5, wherein the one or more heating elements are heating coils.

7. The lamp of claim 5, wherein the one or more heating elements are resistive loads.

8. The lamp of claim 7, including at east two heating elements electrically connected. in series.

8. The lamp of claim 1, wherein the LED light source includes an LED chip.

9. The lamp of claim 1, wherein the LED light source includes two or more LED chips.

10. The lamp of claim 9, wherein the two or more LED chips are positioned at about a longitudinal axis of the lamp.

11. The lamp of claim 9, wherein the two or more LED chips are positioned distal from the lamp base at a distance which locates the LED chips at about the same distance from the lamp base as the center of a conventional vehicle lamp.
